(19) United States
(12) Patent Application Publication
(10) Pub. No.: US 2018/0363768 A1
(43) Pub. Date: Dec. 20, 2018

(54) SHIFT DEVICE

(71) Applicant: KABUSHIKI KAISHA TOKAI-RIKA-DENKI-SEISAKUSHO, Aichi-ken (JP)

(72) Inventors: Naoki KAWASHICHI, Aichi-ken (JP); Tomoki WATANABE, Aichi-ken (JP); Yosuke MURAKAMI, Aichi-ken (JP); Kazumasa KIMATA, Aichi-ken (JP)

(21) Appl. No.: 16/004,756

(22) Filed: Jun. 11, 2018

(30) Foreign Application Priority Data
Jun. 20, 2017 (JP) 2017-120459

(51) Int. Cl. F16H 59/08

(52) U.S. Cl. CPC F16H 59/08; F16H 2059/026; F16H 2059/081

(57) ABSTRACT

A shift device for a vehicle, the shift device includes: a shift body that is rotated so as to change a shift position; and an entry path provided at the shift body, and extending along an outer peripheral side, in a rotation circumferential direction, of the shift body, wherein liquid is able to enter into the entry path.

### CROSS-REFERENCE TO RELATED APPLICATION

This application claims priority under 35 USC 119 from Japanese Patent Application No. 2017-120459 filed Jun. 20, 2017, the disclosure of which is incorporated by reference herein in its entirety.

### BACKGROUND

### Technical Field

The present disclosure relates to a shift device in which a shift body is rotated to change a shift position of the shift body.

### Related Art

In a shift operation device described in the pamphlet of International Publication (WO) No. 2015/107592, a knob is rotated to change a shift position of the knob.

### SUMMARY

In such a shift operation device, it would be preferable to be able to guide liquid (for example a drink) that has entered the knob.

In consideration of the above circumstances, the present disclosure obtains a shift device capable of guiding liquid that has entered a shift body.

A shift device for a vehicle of a first aspect of the present disclosure includes a shift body and an entry path. The shift body is rotated to change a shift position. The entry path is provided at the shift body, and extends along an outer peripheral side, in a rotation circumferential direction of the shift body. Liquid is able to enter the entry path.

A shift device of a second aspect of the present disclosure is the shift device of the first aspect of the present disclosure, further including a drainage section and a drainage groove. The drainage section is provided at the entry path, and includes an outlet through which liquid that has entered the entry path is able to drain. The outlet faces an outer peripheral side of the entry path. The drainage groove is provided at the entry path and extends toward a drainage section side.

A shift device of a third aspect of the present disclosure is the shift device of the second aspect of the present disclosure, wherein the drainage groove extends to the drainage section.

A shift device of a fourth aspect of the present disclosure is the shift device of the second aspect or the third aspect of the present disclosure, wherein the drainage groove extends as far as the outlet of the drainage section.

A shift device of a fifth aspect of the present disclosure is the shift device of the first aspect of the present disclosure, further including a drainage section, a movement path, and a movement groove. The drainage section is provided at the entry path, and allows a liquid that has entered the entry path to drain through an outlet. The outlet faces an outer peripheral side of the entry path. Liquid drained from the drainage section moves along the movement path. The movement groove is provided at the movement path, and extends along an axial direction of the shift body.

In the shift device of the first aspect of the present disclosure, the shift body is rotated to change a shift position of the shift body.

Note that the liquid entry path extends along the outer peripheral side in the rotation circumferential direction of the shift body, and liquid is able to enter the entry path. Liquid that has entered the shift body can thus be guided by the entry path.

In the shift device of the second aspect of the present disclosure, liquid that has entered the entry path of the shift body is able to drain from the entry path through the outlet of the drainage section.

The entry path is provided with the drainage groove, the drainage groove extending toward the drainage section side. Accordingly, since liquid enters the drainage groove, the liquid can be encouraged to move toward the drainage section side, enabling the liquid that has entered the entry path of the shift body to be effectively drained through the drainage section.

In the shift device of the third aspect of the present disclosure, the drainage groove extends to the drainage section. Accordingly, liquid that has entered the drainage groove can be encouraged to move toward the drainage section, enabling the liquid that has entered the entry path of the shift body to be effectively drained through the drainage section.

In the shift device of the fourth aspect of the present disclosure, the drainage groove extends as far as the outlet of the drainage section. This thereby enables liquid that has entered the drainage groove in the drainage section to be encouraged to move, enabling the liquid that has entered the entry path of the shift body to be effectively drained through the outlet of the drainage section.

In the shift device of the fifth aspect of the present disclosure, liquid that has entered the entry path of the shift body is able to drain through the drainage section of the entry path, and the liquid drained through the drainage section moves along the movement path.

Note that the movement groove is provided in the movement path, and the movement groove extends along the axial direction of the shift body. This thereby enables liquid that has entered the movement groove of the movement path to be encouraged to move, enabling the liquid that has been drained from the shift body to be effectively drained through the movement path.

### BRIEF DESCRIPTION OF THE DRAWINGS

An exemplary embodiment will be described in detail based on the following figures, wherein:

FIG. 1 is an exploded perspective view from a left side and rear side illustrating a shift device according to an exemplary embodiment of the present disclosure;

FIG. 2 is a cross-section from an upper side illustrating relevant portions of a shift device according to an exemplary embodiment of the present disclosure;

FIG. 3 is a perspective view from the upper side illustrating a plate and a knob base of a shift device according to an exemplary embodiment of the present disclosure;

FIG. 4A is a side-on perspective view illustrating a knob base of a shift device according to an exemplary embodiment of the present disclosure;

FIG. 4B is a perspective view from the upper side illustrating a knob base of a shift device according to an exemplary embodiment of the present disclosure;

FIG. 5 is a lower face view illustrating a housing of a shift device according to an exemplary embodiment of the present disclosure;

FIG. 6A is a perspective view from the upper side illustrating relevant portions of a knob base of a shift device according to an exemplary embodiment of the present disclosure;

FIG. 6B is a side-on perspective view illustrating relevant portions of a knob base of a shift device according to an exemplary embodiment of the present disclosure;

FIG. 6C is a side-on perspective view illustrating relevant portions of a housing of a shift device according to an exemplary embodiment of the present disclosure;

FIG. 7A is a side-on perspective view illustrating a knob base and a housing of a shift device according to an exemplary embodiment of the present disclosure;

FIG. 7B is an enlarged view illustrating a knob base of a shift device according to an exemplary embodiment of the present disclosure;

FIG. 8A is a side-on perspective view from the upper side illustrating relevant portions of a shift device according to an exemplary embodiment of the present disclosure; and

FIG. 8B is a perspective view from the lower side illustrating a knob base and a housing of a shift device according to an exemplary embodiment of the present disclosure.

### DETAILED DESCRIPTION

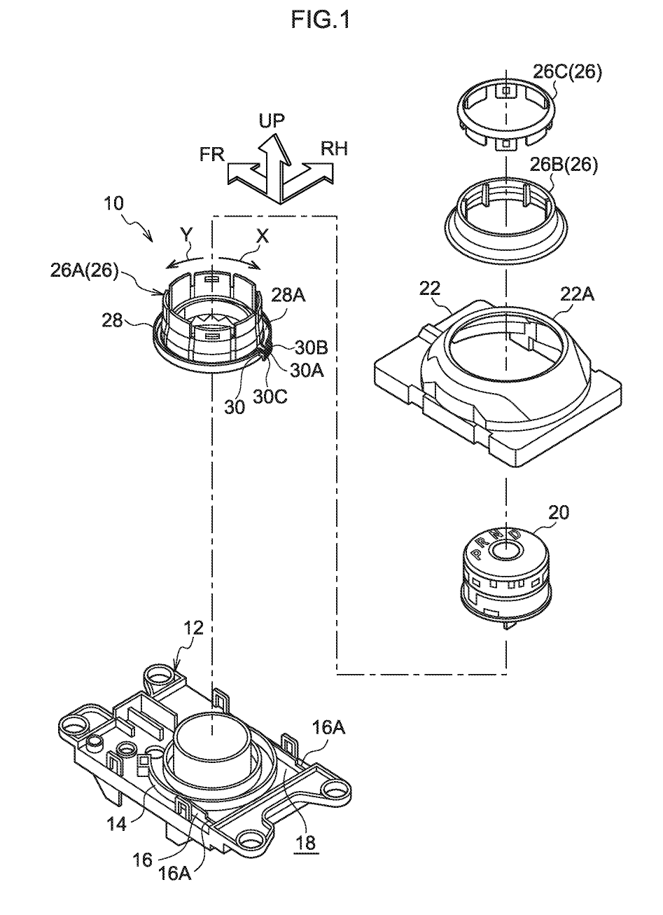

FIG. 1 is an exploded perspective view illustrating a shift device 10 according to an exemplary embodiment of the present disclosure, as viewed from a left side and a rear side. In the drawings, arrow FR indicates a front direction of the shift device 10, arrow RH indicates a right direction of the shift device 10, and arrow UP indicates an upper direction of the shift device 10.

The shift device 10 according to the present exemplary embodiment is installed to a console (vehicle body side) of a vehicle, and is disposed at a vehicle front side and vehicle width direction inner side of a driver's seat (not illustrated in the drawings) of the vehicle. The front, right, and upper side of the shift device 10 respectively face an oblique front upper side of the vehicle, the right of the vehicle, and an oblique rear upper side of the vehicle.

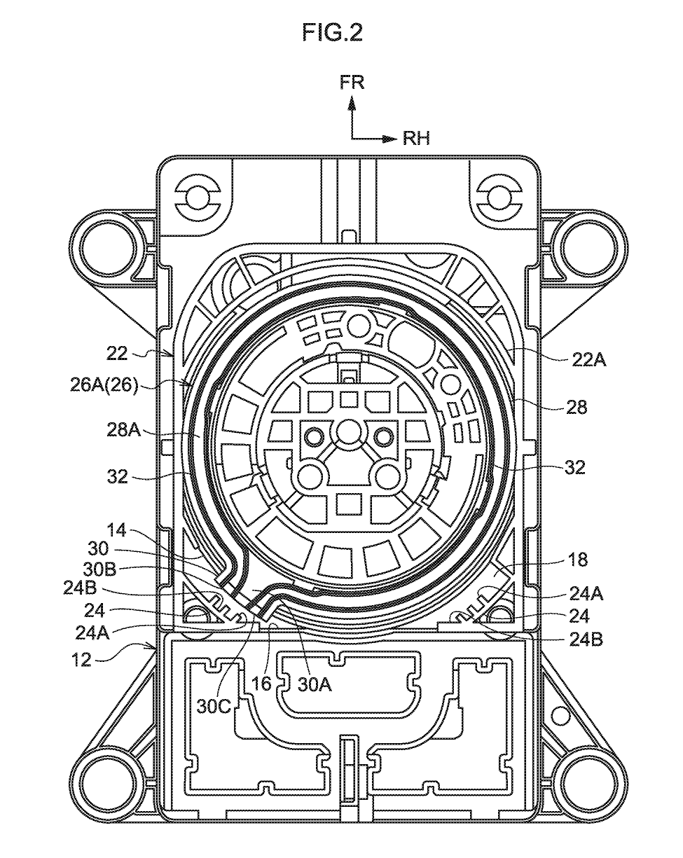

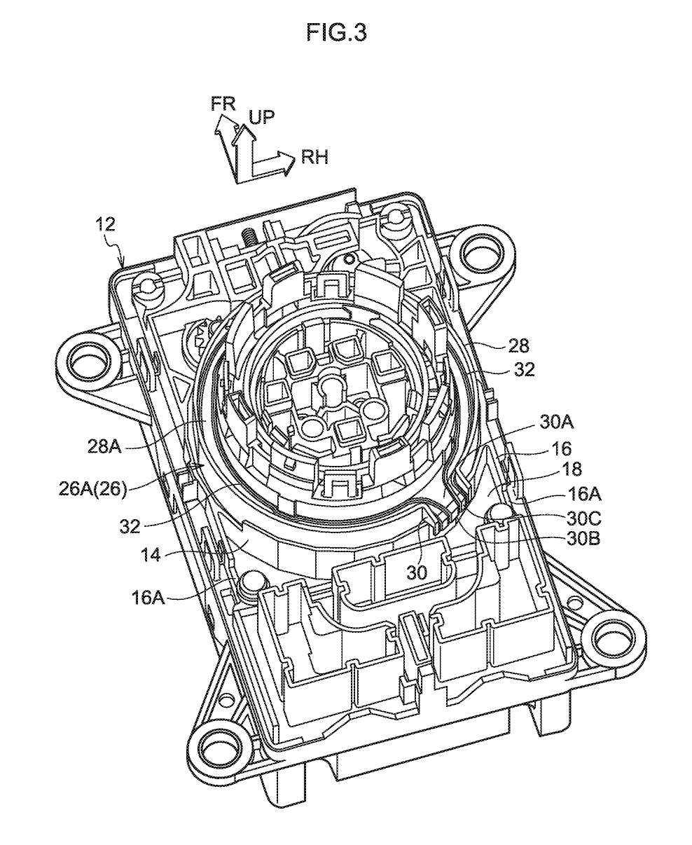

As illustrated in FIG. 1, the shift device 10 is provided with a substantially rectangular plate 12, serving as a support member, and configuring an installed body. The plate 12 is fixed inside the console, and is disposed so as to be perpendicular to an up-down direction. An upper face of the plate 12 is integrally formed with a substantially cylindrical support cylinder 14 (see FIG. 2 and FIG. 3), and an axial direction of the support cylinder 14 is disposed parallel to the up-down direction. The upper face of the plate 12 is also integrally formed with a partitioning frame 16 (see FIG. 2 and FIG. 3) at a rear side of the support cylinder 14. The partitioning frame 16 has a substantially U-shaped cross-section profile. Front ends of a left side portion and a right side portion of the partitioning frame 16 are integrated together with the support cylinder 14. The partitioning frame 16 forms a movement space 18 configuring a movement path between the partitioning frame 16 and the support cylinder 14. The movement space 18 is open toward the upper side. Rectangular movement slots 16A, configuring the movement path, are formed penetrating the rear of the left side portion and the right side portion of the partitioning frame 16. The left side and right side movement slots 16A open toward the upper side, and open up the movement space 18 to a left side and a right side.

A panel 20 that has a bottomed cylindrical shape and that serves as a display member configuring the installed body is fixed inside the support cylinder 14 at an upper side of the plate 12. The panel 20 is disposed coaxially with the support cylinder 14, and passes through the console such that an upper face (base face) of the panel 20 is exposed to a vehicle cabin interior.

A substantially rectangular box shaped housing 22, serving as a covering member configuring the installed body, is fixed to the upper side of the plate 12. The interior of the housing 22 is open toward a lower side, and the housing 22 covers the upper side of the plate 12. An upper wall of the housing 22 is formed with a pierced cylinder 22A that has a substantially frustoconical tube shape. The interior of the pierced tube 22A is in communication with the interior of the housing 22 at the lower side, and the panel 20 passes coaxially through the interior of the pierced tube 22A.

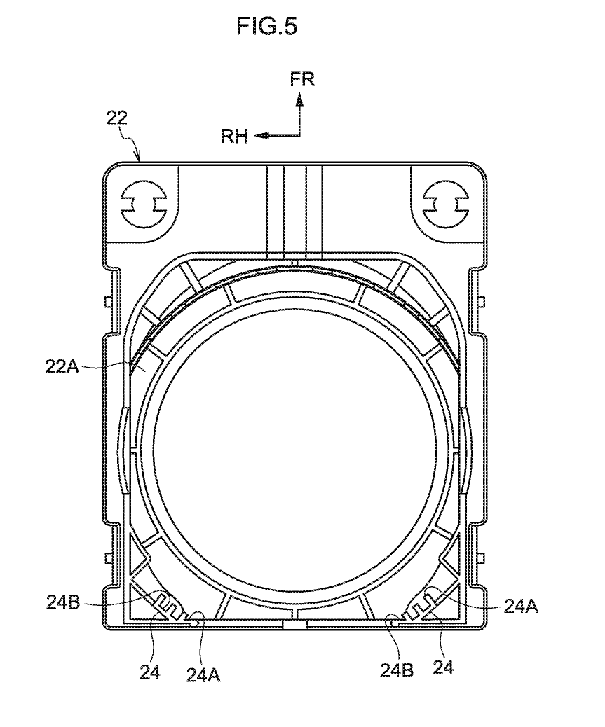

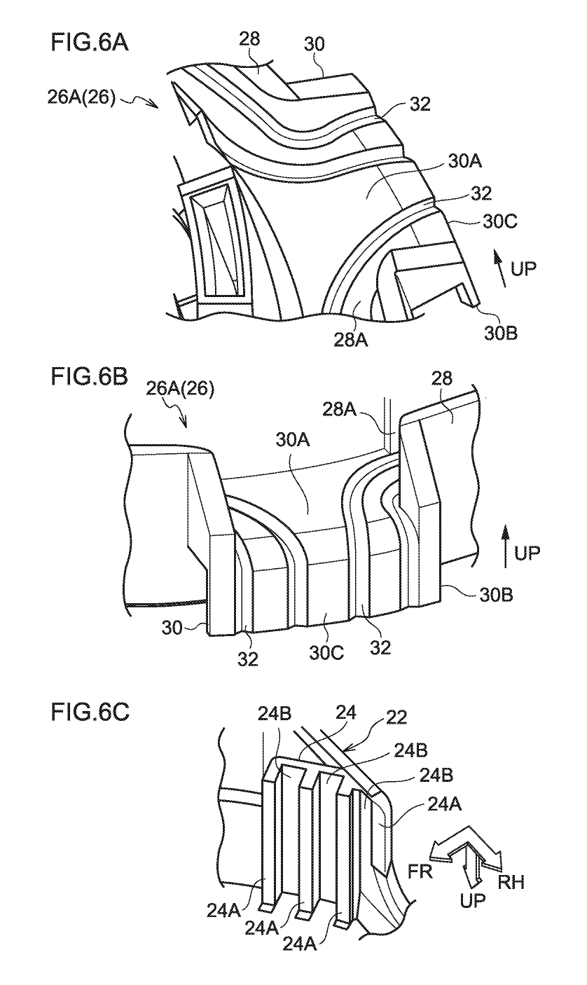

Substantially rectangular plate shaped movement plates 24 (see FIG. 2, FIG. 5, and FIG. 6C) are integrally formed to a lower side of an upper wall of the housing 22a. The movement plates 24 are formed at a left portion and a right portion of a rear end portion of the upper wall of the housing 22a. A rear end of each movement plate 24 is integrated with a rear wall of the housing 22. The movement plates 24 are angled in directions toward left-right direction outer sides of the housing 22 on progression toward the front side, and a movement path is configured at a front side of each movement plate 24 (on a side of the support cylinder 14 of the plate 12). Plural (four in the present exemplary embodiment) ribs 24A are integrally formed to the front side of each movement plate 24. Each of the plural ribs 24A extends in the up-down direction, and is separated from one another in a horizontal direction. Movement grooves 24B are formed between the respective ribs 24A. Each movement groove 24B extends in the up-down direction, and is open at a lower side.

A substantially cylindrical knob 26, serving as a shift body, is supported at the upper side of the plate 12. The knob 26 is disposed coaxially to the support cylinder 14 of the plate 12.

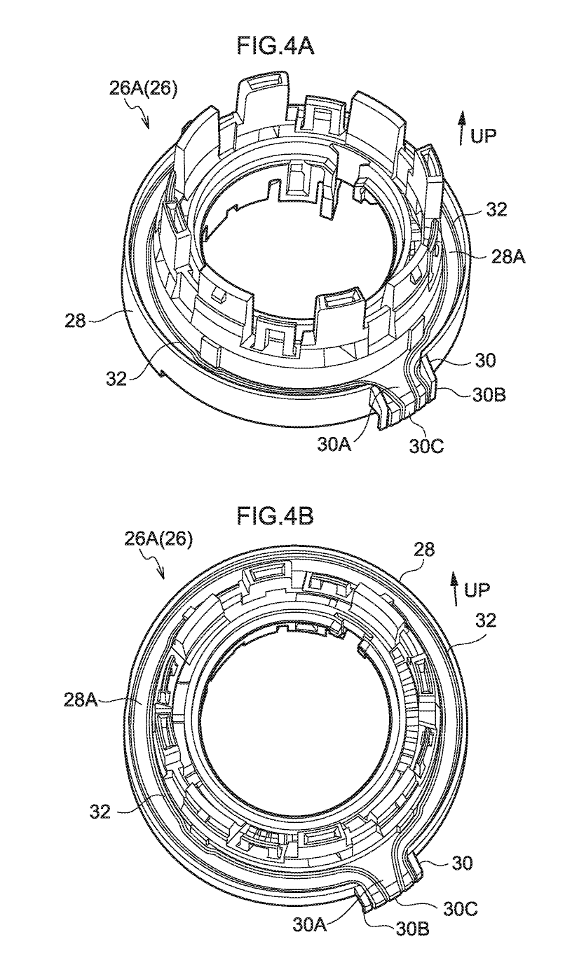

A knob 26 is provided with a substantially cylindrical knob base 26A (see FIG. 2, FIG. 3, FIG. 4A, and FIG. 4B), serving as a main body. The panel 20 passes coaxially through an interior of the knob base 26A, and the knob base 26A passes coaxially through the pierced tube 22A of the housing 22. An annular flow path frame 28 with a horizontal T-shaped cross-section profile is integrally formed at an outer periphery of a lower end of the knob base 26A. The flow path frame 28 is disposed coaxially to the knob base 26A. An outer peripheral face of the flow path frame 28 fits coaxially into the support cylinder 14 of the plate 12, such that the knob base 26A is capable of rotating within a predetermined range with respect to the plate 12. An outer periphery of a lower portion of the knob base 26A and an upper side portion of the flow path frame 28 form a flow path 28A that configures an entry path and has a rectangular cross-section profile. The flow path 28A is open at an upper side and is disposed running along the entire periphery of the knob base 26A.

A drainage frame 30, serving as a drainage section, is integrally formed to the outer periphery of the flow path frame 28. The drainage frame 30 projects toward a radial direction outer side of the flow path frame 28, and an upper side portion of the drainage frame 30 is formed with a rectangular drainage opening 30A configuring the entry path. The drainage opening 30A is open toward an upper side, and opens up the flow path 28A to a radial direction outer side of the flow path frame 28. A lower side portion of the drainage frame 30 configures a rectangular plate shaped drainage plate 30B. The drainage plate 30B extends toward a lower side at a position on a radial direction outer side edge of the flow path frame 28, and is disposed at a radial direction outer side of the support cylinder 14 of the plate 12 (in the movement space 18). A face of the drainage plate 30B on the radial direction outer side of the flow path frame 28 configures a drainage face 30C, and the entry path is configured by the drainage face 30C at the radial direction outer side of the flow path frame 28.

Drainage grooves 32, each having a substantially triangular cross-section profile, are formed at a radial direction inner side edge and radial direction outer side edge of a lower face of the flow path 28A. Each drainage groove 32 extends substantially along the entire circumferential direction of the flow path 28A. Two extension direction end portions of the drainage groove 32 at the radial direction inner side edge of the flow path 28A respectively extend toward a lower face of the drainage opening 30A and intermediate portions in a circumferential direction of the drainage face 30C. The two extension end portions of the drainage groove 32 at the radial direction outer side edge of the flow path 28A respectively extend toward the lower face of the drainage opening 30A and both end portions in the circumferential direction of the drainage face 30C (see FIG. 6A and FIG. 6B).

A substantially annular frame shaped first rotary member 26B, serving as a first exposed portion, is fixed to an outer peripheral side of an upper end portion of the knob base 26A so as to be coaxial to and capable of rotating as a unit with the knob base 26A. The first rotary member 26B covers an upper end portion of the pierced tube 22A from the upper side. A substantially annular frame shaped second rotary member 26C, serving as a second exposed portion, is fixed to an upper side of the first rotary member 26B so as to be coaxial to and capable of rotating as a unit with the first rotary member 26B. An upper end of the second rotary member 26C is rotatably fitted to an outer periphery of an upper face of the panel 20.

The first rotary member 26B and the second rotary member 26C pass through the console and are exposed to the vehicle cabin interior. The knob 26 can be operated rotationally within a predetermined range by an occupant of the vehicle (in particular, a driver seated in the driver's seat) using the first rotary member 26B and the second rotary member 26C. Shift positions can be changed by rotating the knob 26 in one direction (the arrow X direction in FIG. 1) or another direction (the arrow Y direction in FIG. 1). In sequence from the other direction side toward the one direction side, the knob 26 can be placed at a P position (parking position, first shift position), an R position (reverse position), an N position (neutral position, first shift position), and a D position (drive position, second shift position), respectively serving as shift positions.

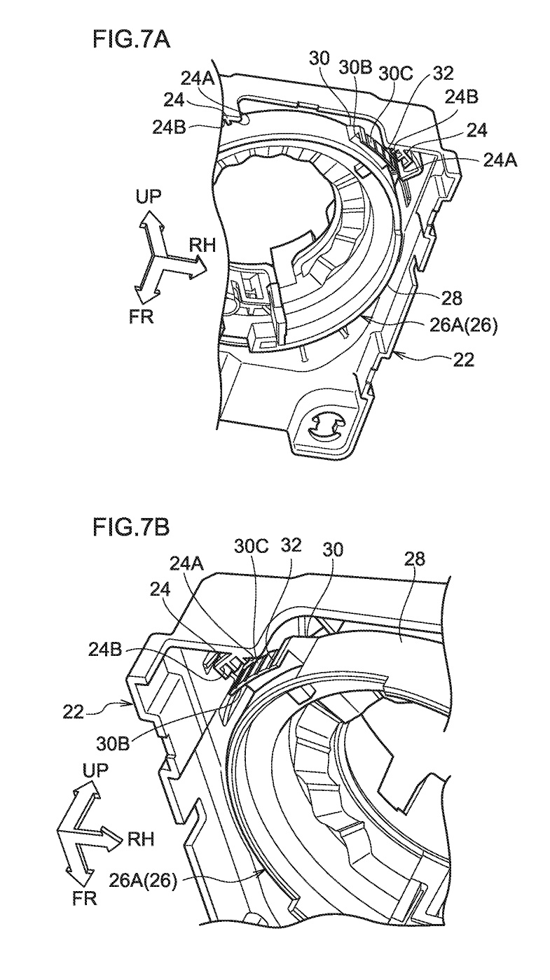

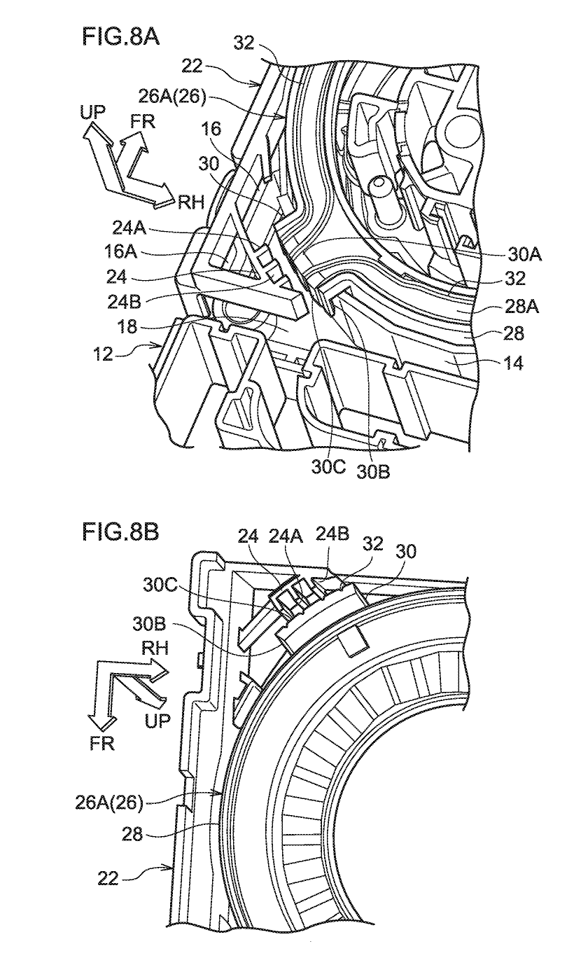

When the knob 26 has been disposed at the P position, the drainage opening 30A and the drainage face 30C of the knob 26 (knob base 26A) face toward a front side of the movement plate 24 on the right side of the housing 22 (see FIG. 7A), and when the knob 26 has been disposed at the D position, the drainage opening 30A and the drainage face 30C face a front side of the movement plate 24 on the left side of the housing 22 (see FIG. 2, FIG. 7B, FIG. 8A, and FIG. 8B).

A shift locking mechanism (not illustrated in the drawings), serving as a restriction section, is provided at the upper side of the plate 12, further to a front side from the movement space 18 (for example, at a front side of the knob 26). The shift locking mechanism locks (restricts) rotation of the knob 26 at a predetermined shift position (for example, the P position) at a predetermined stimulus.

A rotation mechanism (not illustrated in the drawings), serving as a rotation section, is provided at the upper side of the plate 12, further toward a front side from the movement space 18 (for example, at the lower side of the knob 26). The rotation mechanism rotates the knob 26 to a given shift position (for example, the P position) at a given stimulus.

Next, explanation follows regarding operation of the present exemplary embodiment.

In the shift device 10 configured as described above, the shift position of the knob 26 is changed to the P position, the R position, the N position, or the D position by rotation operating the knob 26.

The flow path 28A at the outer periphery of the knob 26 (knob base 26A) extends along the circumferential direction of the knob 26. Should a liquid (for example a drink) flow down from an upper side of the shift device 10, the liquid would enter the shift device 10 between the knob 26 and the upper end portion of the pierced tube 22A of the housing 22, and would be capable of entering the flow path 28A. The liquid that has flowed into the shift device 10 from the upper side of the shift device 10 can thus be guided by the flow path 28A.

Moreover, the drainage grooves 32 are formed in the lower face of the flow path 28A of the knob 26. The drainage grooves 32 extend around substantially the entire flow path 28A in the circumferential direction. Accordingly, even if the liquid in the flow path 28A is viscous, for example, since the liquid enters the drainage grooves 32, capillary action facilitates movement of the liquid along the drainage grooves 32. The liquid can thus be encouraged to move toward the drainage frame 30 side of the knob 26 (knob base 26A), enabling the drainage frame 30 to drain the liquid effectively. This thereby enables liquid to be suppressed from collecting in the flow path 28A, enables the liquid in the flow path 28A to be suppressed from scattering when the knob 26 is rotated, and enables the liquid to be suppressed from affecting the shift locking mechanism and the rotation mechanism.

Moreover, the drainage grooves 32 of the flow path 28A extend along the drainage frame 30 (the lower face of the drainage opening 30A, and the drainage face 30C). This enables liquid that has entered the drainage grooves 32 of the flow path 28A to be encouraged to move toward the drainage frame 30, enabling the liquid in the flow path 28A to be even more effectively drained through the drainage frame 30.

Moreover, the drainage grooves 32 extend over the lower face of the drainage opening 30A, and the drainage face 30C, of the drainage frame 30. This thereby enables the liquid that has entered the drainage grooves 32 of the drainage frame 30 to be encouraged to move, enabling the liquid in the drainage frame 30 to be effectively drained through the drainage frame 30.

The liquid drained through the drainage frame 30 (drainage opening 30A and drainage face 30C) of the knob 26 flows down into the movement space 18 in the plate 12. When the knob 26 has been placed at the P position or the D position, the drainage opening 30A and the drainage face 30C of the knob 26 oppose the front side of the right movement plate 24 or the left movement plate 24 of the housing 22.

The movement grooves 24B are formed at the front side of the respective movement plates 24. Each movement groove 24B extends in the up-down direction, and is open at the lower side. Accordingly, even if the liquid drained through the drainage frame 30 is viscous, for example, when the liquid enters the movement grooves 24B, capillary action facilitates movement of the liquid along the movement grooves 24B. This enables the liquid at the front sides of the movement plates 24 to be encouraged to flow down toward the movement space 18, and enables the liquid drained through the drainage frame 30 to be effectively made to flow down into the movement space 18. This thereby enables the liquid to be effectively drained from the movement space 18 to the outside of the shift device 10 through the movement slots 16A in the plate 12 and through gaps between side walls of the housing 22 and the plate 12.

Note that in the present exemplary embodiment, the drainage frame 30 is provided at the flow path frame 28 of the knob 26. However, configuration may be made in which the drainage frame 30 is not provided at the flow path frame 28 of the knob 26, and the entire periphery of the flow path 28A inside the flow path frame 28 is not open at the radial direction outer side.

Moreover, in the present exemplary embodiment, the knob 26 is operated rotationally by an occupant. However, a lever (shift section) may be provided capable of rotating as a unit with the knob 26, such that the knob 26 is rotated by swinging operation of the lever by the occupant

Moreover, in the present exemplary embodiment, the shift device 10 is installed to the console. However, the shift device 10 may be installed to a floor of the vehicle cabin, an instrument panel, or a steering column cover.

What is claimed is:

1. A shift device for a vehicle, the shift device comprising:
a shift body that is rotated so as to change a shift position; and
an entry path provided at the shift body, and extending along an outer peripheral side, in a rotation circumferential direction, of the shift body, wherein liquid is able to enter into the entry path.

2. The shift device of claim 1, further comprising:
a drainage section provided at the entry path, and including an outlet through which liquid that has entered the entry path is able to drain, the outlet facing an outer peripheral side of the entry path; and
a drainage groove provided at the entry path and extending toward the drainage section.

3. The shift device of claim 2, wherein the drainage groove extends to the drainage section.

4. The shift device of claim 2, wherein the drainage groove extends as far as the outlet of the drainage section.

5. The shift device of claim 1, further comprising:
a drainage section provided at the entry path, and allowing a liquid that has entered the entry path to drain through an outlet, the outlet facing an outer peripheral side of the entry path;
a movement path along which liquid drained from the drainage section moves; and
a movement groove provided at the movement path, and extending along an axial direction of the shift body.
